(19) United States
(12) Patent Application Publication
(10) Pub. No.: US 2008/0320447 A1
(43) Pub. Date: Dec. 25, 2008

(54) METHOD OF ACCESSING WEB PARAMETERS

(76) Inventor: Chun-Hao Chang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/040,921

(22) Filed: Mar. 3, 2008

(30) Foreign Application Priority Data
Jun. 23, 2007 (TW) 096122795

(51) Int. Cl. G06F 9/44

(52) U.S. Cl. 717/121

(57) ABSTRACT

A method of accessing Web parameters includes: providing a first program code for managing at least one Web parameter, where the Web parameter is stored in a parameter set and the first program code is a light-weight program code; and when a second program code is executed, accessing the Web parameter stored in the parameter set by utilizing the first program code.

### BACKGROUND OF THE INVENTION

1. Field of the Invention

The present invention relates to a method of accessing parameters, and more particularly, to a method of centrally managing and accessing web parameters by utilizing a light-weight program code.

2. Description of the Prior Art

As Internet applications progress popularly nowadays, most information can be expressed through websites, and the website development becomes more and more prosperous with diversification. Generally, there are many web pages and related multimedia applications in the websites. As a result, web developers have to write more and more web program codes in order to satisfy these requirements. It is noted that when the web developers develop the websites, a lot of variables (which are referred to as parameters hereinafter) are utilized to access related data. However, simple parameter accessing functions cannot satisfy the requirements of various situations for the web developers. Therefore, a method for accessing parameters with flexibility and uniformity in the mutual development environment is required.

In general, during a website development period, the same website may be written and completed by many web developers. If the website developers utilize the same parameter name among different web program codes of the same website, this will lead to confusion since the parameters in different web program codes with the same parameter name cannot be easily identified. In addition, if the same web program code is written by different developers and one of the developers does not understand the meaning of the parameter(s) in the web program code architecture, the developer may misuse the parameter(s), hindering the development process and causing the web program code to be buggy.

On the other hand, when the website is completed and settled online, and further maintained by a website manager, the website manager may not understand effects of the parameters within the website architecture, causing difficulty of maintaining the website manager. Furthermore, if the website manager changes a parameter name, the website manager needs update all of web pages utilizing the parameter of the parameter name, which is a very minute and complicated, and therefore, is time consuming.

In conclusion, for the website developers and/or website managers, the prior art parameter accessing approach limits the using flexibility for the website developers during the website development process, and may increase the difficulty and complexity of accessing the web parameters for the website managers during the website manager maintaining process. As a result, how to determine the web parameters in the web program codes for easily managing and maintaining the web parameters is an important issue of web program code development.

### SUMMARY OF THE INVENTION

Therefore, it is one of the objectives of the claimed invention to provide a method of accessing the web parameters by utilizing an accessing approach of a light-weight program code for accessing the web parameters during the development process of the Web pages. The method is capable of setting an accessing web page, a life cycle, an accessing frequency, an accessing range and an encryption approach of the web parameters, where the web parameters are stored by utilizing an object oriented approach.

In addition, according to an exemplary embodiment of the present invention, a light-weight program code is further disclosed. The light-weight program code may execute steps of adding, modifying, or deleting a condition or a value of the web parameter, and may dump all web parameters of a parameter set to generate a dumping result and reload the dumping result into the parameter set, where the web parameters are stored by utilizing an object oriented approach.

According to an exemplary embodiment of the present invention, a method of accessing web parameters is disclosed. The method comprises: providing a first program code for managing at least a web parameter, where the web parameter is stored in a parameter set; and when a second program code is executed, accessing the web parameter from the parameter set by utilizing the first program code.

According to an exemplary embodiment of the present invention, a method of accessing web parameters is further disclosed. The method comprises: requiring a first program code by utilizing a second program code to access a web parameter; receiving the web parameter from a parameter set and validating condition states of the web parameter by utilizing the first program code; and returning the web parameter back to the second program code by utilizing the first program code when the condition state of the web parameter is correct.

According to an exemplary embodiment of the present invention, a method of accessing web parameters is further disclosed. The method comprises: directly requiring a parameter management program code by utilizing a command to modify a condition or a value of a web parameter; and returning an execution result of the command by utilizing the parameter management program code.

The present invention utilizes an accessing approach with a light-weight program code for accessing the web parameters to achieve advantages of uniformly managing the web parameters, reducing the complexity of developing web pages, and reducing the confusion of the web parameters. In addition, the methods disclosed by the present invention may relieve distress of complexity of the web parameters and the corresponding management difficulty since the methods disclosed by the present invention greatly reduce the time required for developing web pages and further reduce the possibility of error occurrence.

In conclusion, during the web developing process, developers may understand clearly and utilize the accessed web parameters and managers may maintain and modify the conditions or values of the web parameters with a clear concept by utilizing the web parameter accessing approach provided by the present invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an operating diagram of an approach of accessing web parameters according to one embodiment of the present invention.

FIG. 2 is a diagram of a web page management interface according to one embodiment of the present invention.

FIG. 3 is a diagram of a web page management program code according to an embodiment of the present invention.

FIG. 4 is a flowchart of a method of accessing web parameters according to a first operating embodiment of the present invention.

FIG. 5 is a flowchart of a method of accessing web parameters according to a second operating embodiment of the present invention.

FIG. 6 is a flowchart of a method of accessing web parameters according to a third operating embodiment of the present invention.

### DETAILED DESCRIPTION

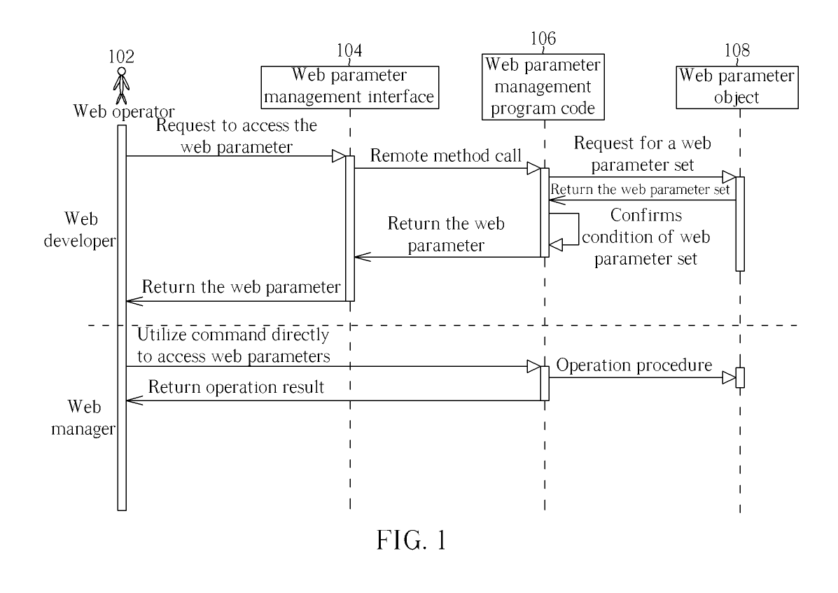

Please refer to FIG. 1. FIG. 1 is an operating diagram of an approach of accessing web parameters according to one embodiment of the present invention, where the web parameters can also be referred to as web variables hereinafter. As shown in FIG. 1, when a web operator 102 is a web developer and the web developer utilizes a web parameter for writing a web program code, then the web operator 102 requests to access the web parameter by utilizing a web parameter management interface 104. If the web parameter exists, the web operator 102 does not have to further create the web parameter as a new parameter; otherwise, the web operator 102 has to create the web parameter as a new parameter. When the web operator 102 requests to access the web parameter by utilizing the web parameter management interface 104, the web parameter management interface 104 transmits a method call to call a web parameter management program code 106 for executing the related web parameter access. Thus, the web parameter management program code 106 transmits a request for a web parameter set to a web parameter object 108, and then the web parameter object 108 collects related web parameters of the web parameter set, and returns the web parameter set back to the web parameter management program code 106. That is, in this embodiment, the web parameter is stored by utilizing an object oriented approach. Accordingly, the web parameter management program code 106 confirms the condition (or a value representing the condition) of the web parameter set. If the condition is correct and accessing the web parameter is permitted, then the web parameter object 108 returns the requested web parameter set back to the web parameter management program code 106, and the web parameter management program code 106 returns the requested web parameter set back to the web parameter management interface 104, and further, the web parameter management interface 104 returns the requested web parameter set back to the web operator 102. As a result, the web operator 102 may access the requested web parameter.

Similarly, As shown in FIG. 1, if a web operator 102 is a web manager and the web manager modifies a condition or a value of a web parameter of a web page during a process of managing web page, the web operator 102 may dump all web parameters by utilizing the web parameter management interface 104 to generate a dumping result for backup, and further executes a backup process automatically by utilizing the web parameter management program code 106 during a life cycle. As a result, when an error of the web parameter occurs, the dumping result can be reloaded to restore the correct web parameters. In addition, the web operator 102 may utilize a command to manage all of the web parameters by utilizing the web parameter management program code 106. When the web parameter management program code 106 receives the command, the web parameter management program code 106 executes a step of adding, modifying, or deleting conditions or values of one web parameter of the web parameter object 108 according to the command. Finally, the web parameter management program code 106 returns an execution result of command back to the web operator 102.

It should be note that the condition is selected from related settings, such as a web page access setting, a life cycle setting, an access frequency setting, an access range setting, or an encryption approach setting of the web parameter. In addition, in this embodiment, the web parameter management program code 106 is a light-weight program code, where the light-weight program code represents a program code whose sized is reduced with the origin functions being achieved. The light-weight program code can be executed by utilizing a memory of a limited memory size, so no extra memory space is required for the huge size of the original program code. Accordingly, regarding the light-weight program code, a person skilled in the programming art would appreciate that the web parameters management approach utilized by the web parameter management program code 106 of the present invention is different from the data management approach of the prior art database.

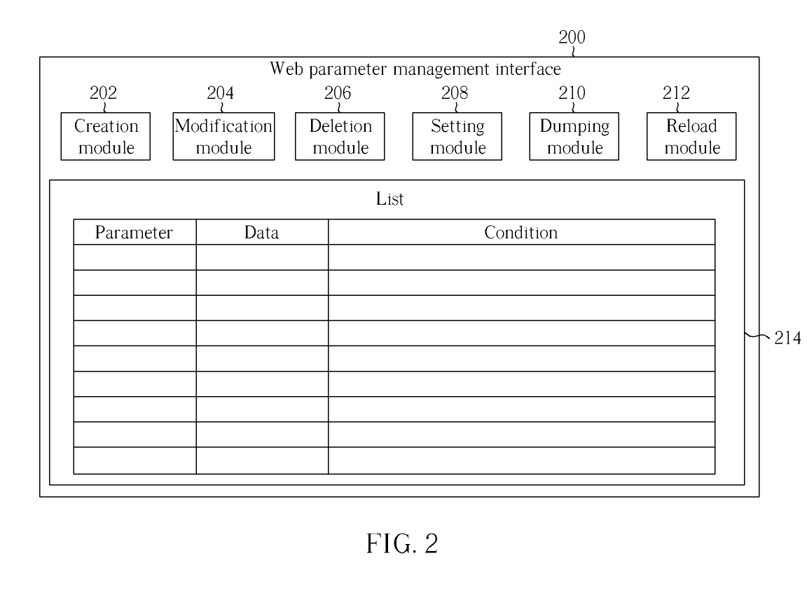

Please refer to FIG. 2. FIG. 2 is a diagram of a web parameter management interface 200 according to one embodiment of the present invention. As shown in FIG. 2, the web parameter management interface 200 further illustrates some details of the web parameter management interface 104 shown in FIG. 1. In this embodiment, the web parameter management interface 200 comprises a creation module 202, a modification module 204, a deletion module 206, a setting module 208, a dumping module 210, a reload module 212 and a list 214. The creation module 202 is utilized for adding a web parameter or a condition/value of the web parameter. The modification 204 is utilized for modifying the condition or value of the web parameter. The deletion module 206 is utilized for deleting the stored web parameter or the stored condition/value of the web parameter in the list 214. The setting module 208 is utilized for setting an access web page, a life cycle, an access frequency, an access range, and an encryption approach of the web parameter. The dumping module 210 is utilized for dumping all the stored web parameters to generate a dumping result for backup. The reload module 212 is utilized for reloading the dumping result to restore the web parameter when an error of the web parameter occurs. The list 214 is utilized for listing all of the stored web parameters, where the list 214 comprises a parameter, a set of data, and a condition. It should be noted that the format of the list 214 mentioned above is not meant to be a limitation of the present invention.

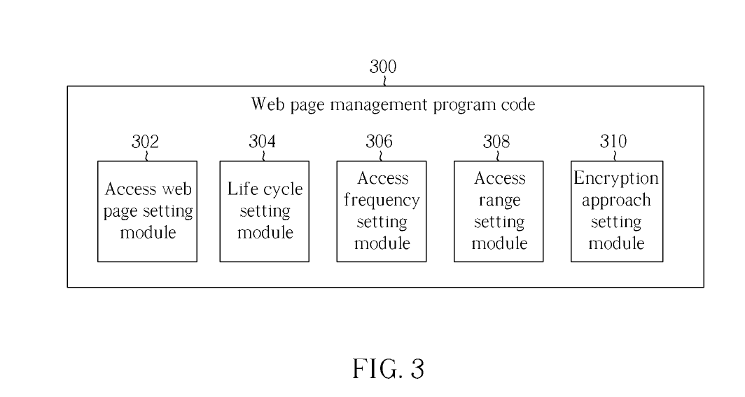

Please refer to FIG. 3. FIG. 3 is a diagram of a web page management program code 300 according to an embodiment of the present invention. As shown in FIG. 3, the web page management program code 300 further illustrates some details of the web parameter management program code 106 shown in FIG. 1. In this embodiment, the web page management program code 300 comprises an access web page setting module 302, a life cycle setting module 304, an access frequency setting module 306, an access range setting module 308, and an encryption approach setting module 310. The access web page setting module 302 is utilized for setting the web page management program code 300 to be capable of controlling at least one accessed web page comprising a single page or a plurality of pages. The life cycle setting module 304 is utilized for setting the web page management program code 300 to be capable of controlling a life cycle of the web parameter, where the life cycle may be a relative time or an absolute time measured in a time unit, such as a year, a month, a day, an hour, a minute, or a second. If the access time of the web parameter accessed by a web page is greater than the set life cycle time of the web parameter, the web page is not capable of accessing the web parameter. For example, the life cycle time of the web parameter is 14:00:00, May 22, 2007, and the time of accessing the web parameter by the web page is 14:00:12, May 22, 2007, the web page is not capable of accessing the web parameter. The access frequency setting module 306 is utilized for setting the web page management program code 300 to be capable of controlling an access frequency of the web parameter, where if the access frequency of the web parameter accessed by a web page is greater than the set access frequency of the web parameter, the web page is not capable of accessing the web parameter. The access range setting module 308 is utilized for setting the web page management program code 300 to be capable of controlling an access range of the web parameter, where the characteristic of the access range is capable of being so-called “world”, “public”, “private”, or “friendly” (e.g. the access range may be declared as “world”, “public”, “private”, or “friendly”). If the access range of the web parameter is declared as “world”, the web parameter may be accessed by all of the web pages in a same website. If the access range of the web parameter is declared as “public”, the web parameter may be accessed by different the program codes in a same web page. If the access range of the web parameter is declared as “private”, the web parameter may be accessed by a same program codes in a same web page. If the access range of the web parameter is declared as “friendly”, the web parameter may be accessed by different ones of the web pages in a same data file. The encryption approach setting module 310 is utilized for setting the web page management program code 300 to be capable of controlling an encryption approach of the web parameter, where the encryption approach may utilize a prior art encryption algorithm for encrypting the web parameter to avoid leaking the important information of the web parameter.

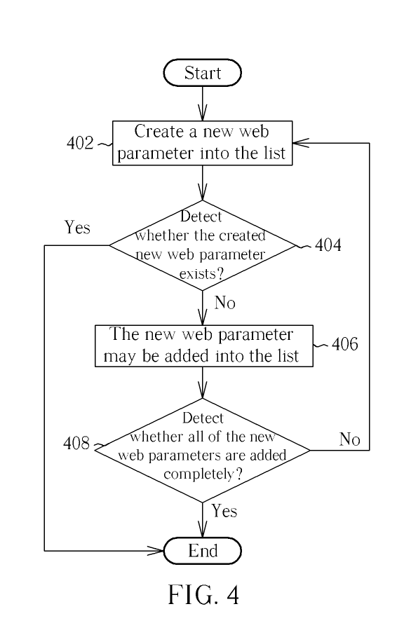

Please refer to FIG. 1, FIG. 2 and FIG. 4 at the same time. FIG. 4 is a flowchart of a method of accessing web parameters according to a first operating embodiment of the present invention. As shown in FIG. 4, first, in Step 402, the web operator 102 triggers the creation module 202 in the web parameter management interface 200 for adding a web parameter into the list 214. Then, in Step 404, the web parameter management program code 106 detects whether the added web parameter exists. If the added web parameter exists, the web operator 102 does not add the web parameter and the working flow is ended. In Step 406, if the added web parameter does not exist, the web parameter may be added into the list 214. In Step 408, the web parameter management program code 106 detects whether all of the new web parameters are added completely. If the above-mentioned detection result is true, the working flow is ended; otherwise (i.e. the above-mentioned detection result is false), the working flow is returned back to Step 402 and repeated until all of the new web parameters are added completely.

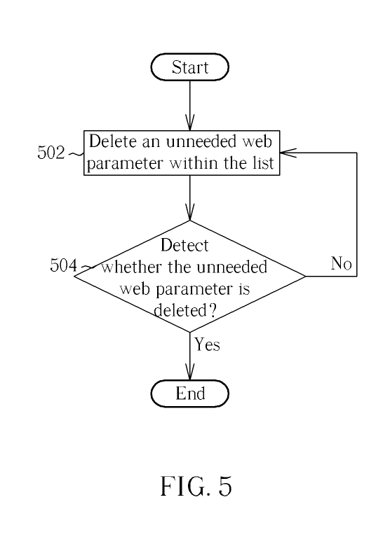

Please refer to FIG. 1, FIG. 2 and FIG. 5 at the same time. FIG. 5 is a flowchart of a method of accessing web parameters according to a second operating embodiment of the present invention. As shown in FIG. 5, first, in Step 502, the web operator 102 triggers the deletion module 206 in the web parameter management interface 200 for deleting an unneeded web parameter within the list 214. Then, in Step 504, the web parameter management program code 106 detects whether the unneeded web parameter is deleted. If the above-mentioned detection result is true, the working flow is ended; otherwise (i.e. the above-mentioned detection result is false), the working flow is returned back to Step 502 and repeated until the deletion process is complete.

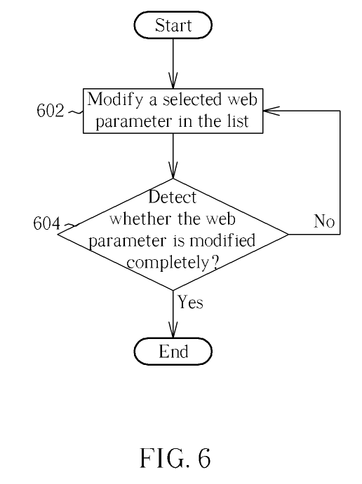

Please refer to FIG. 1, FIG. 2 and FIG. 6 at the same time. FIG. 6 is a flowchart of a method of accessing web parameters according to a third operating embodiment of the present invention. As shown in FIG. 6, first, in Step 602, the web operator 102 triggers the modification module 208 in the web parameter management interface 200 for modifying a selected web parameter in the list 214. Continuously, in Step 604, the web parameter management program code 106 detects whether the web parameter is modified completely. If the above-mentioned detection result is true, the working flow is ended; otherwise (i.e. the above-mentioned detection result is false), the working flow is returned back to Step 602 and repeated until the modification process is complete.

In addition, according to an alternative design of the present invention, the web operator 102 may represent a plurality of web developers. When the plurality of web developers writes different web program codes respectively, and utilizes the same web parameter during the web developing process, the web parameter is managed uniformly by utilizing the web parameter management interface 104. When one of the web developers utilizes the web parameter, another of the web developers does not perform any modification and change for the web parameter. This alternative design still falls within the scope of the present invention.

According to another alternative design of the present invention, the web parameter management interface 104 and the web parameter management program code 106 may be placed on different systems respectively. When the web operator 102 executes related modules of the web parameter management interface 104, the web parameter management interface 104 may trigger the web parameter management program code 106 to perform functions of needed modules for accessing the web parameter.

Those skilled in the art will readily observe that numerous modifications and alterations of the device and method may be made while retaining the teachings of the invention.

What is claimed is:

1. A method of accessing web parameters, comprises:
providing a first program code for managing at least a web parameter, wherein the web parameter is stored in a parameter set; and
when a second program code is executed, accessing the web parameter from the parameter set by utilizing the first program code.

2. The method of claim 1, wherein the step of providing the first program code for managing the web parameter comprises at least one step selected from a group consist of controlling a stored web page, controlling a life cycle of the web parameter, controlling an access frequency of the web parameter, controlling an access range of the web parameter, controlling an encryption approach of the web parameter, and editing a condition or a value of the web parameter.

3. The method of claim 2, wherein the step of editing the condition or the value of the web parameter comprises at least one step selected from a group consist of adding, modifying, and deleting.

4. The method of claim 2, wherein the characteristic of the access range is capable of being world, public, private, or friendly.

5. The method of claim 1, wherein the step of providing the first program code for managing the web parameter further comprises:
setting the first program code to be capable of dumping all of the web parameters of the parameter set to produce a dumping result.

6. The method of claim 5, wherein the step of providing the first program code for managing the web parameter further comprises:
setting the first program code to be capable of reloading the dumping result into the parameter set.

7. The method of claim 1, wherein the parameter set is stored by utilizing an object oriented approach.

8. A method of accessing web parameters comprises:
requiring a first program code by utilizing a second program code to access a web parameter;
receiving the web parameter from a parameter set and validating condition states of the web parameter by utilizing the first program code; and
returning the web parameter back to the second program code by utilizing the first program code when the condition states of the web parameter are correct.

9. A method of accessing web parameters comprises:
directly requiring a parameter management program code by utilizing a command to modify a condition or a value of a web parameter; and
returning an execution result of the command by utilizing the parameter management program code.
